(19) United States
(12) Patent Application Publication
(10) Pub. No.: US 2017/0088044 A1
(43) Pub. Date: Mar. 30, 2017

(54) Vehicle Occupant Safety System

(71) Applicants: Luther Hensley, Richmond, KY (US); Allen Daniel Maras, Ravenna, KY (US)

(72) Inventors: Luther Hensley, Richmond, KY (US); Allen Daniel Maras, Ravenna, KY (US)

(21) Appl. No.: 14/865,177

(22) Filed: Sep. 25, 2015

(51) Int. Cl. B60Q 5/00; G01S 13/04; G01S 15/04

(52) U.S. Cl. CPC B60Q 5/005; G01S 15/04; G01S 13/04

(57) ABSTRACT

Apparatus and methods for the generation of an alarm signal when it is determined that the vehicle cabin is occupied when the vehicle cabin temperature falls outside of a predetermined range of acceptable temperatures.

### TECHNICAL FIELD

The present application describes a system to alert as to the presence of a rear seat occupant in an unattended vehicle. More specifically, the present invention relates to a system to alert as to the presence of a rear seat occupant in an unattended vehicle when the interior temperature is outside of a safe range.

### BACKGROUND

Temperatures in a parked car can reach dangerously elevated levels quickly, even when the outside temperature is quite moderate. Conversely, low temperatures can also be dangerous. Exposure to extreme temperatures, especially for the very young and as those of advanced age, can cause serious injury or even death. Consequently, there is a need for a system that may lessen or eliminate the risk of fatality or injury to a passenger left unattended in a vehicle's interior as temperatures become inhospitable.

A motion detector is a device that contains a mechanism that quantifies motion. For example, a motion detector can transform the detection of motion into an electrical signal. An electronic motion detector contains an optical, microwave, or acoustic sensor, and in many cases a transmitter for illumination.

There are several motion detection technologies in wide use:

### Passive Infrared (PIR)

Passive infrared sensors are sensitive to a person's skin temperature through emitted black body radiation at mid-infrared wavelengths, in contrast to background objects at room temperature. No energy is emitted from the sensor, thus the name “passive infrared” (PIR). This distinguishes it from the electric eye for instance (not usually considered a “motion detector”), in which the crossing of a person or vehicle interrupts a visible or infrared beam.

### Microwave

These detect motion through the principle of Doppler radar, and are similar to a radar speed gun. A continuous wave of microwave radiation is emitted, and phase shifts in the reflected microwaves due to motion of an object toward (or away from) the receiver result in a heterodyne signal at low audio frequencies.

### Ultrasonic

An ultrasonic wave (sound at a frequency higher than a human can hear) is emitted and reflections from nearby objects are received. Exactly as in Doppler radar, heterodyne detection of the received field indicates motion. The detected Doppler shift is also at low audio frequencies (for walking speeds) since the ultrasonic wavelength of around a centimeter is similar to the wavelengths used in microwave motion detectors. One potential drawback of ultrasonic sensors is that the sensor can be sensitive to motion in areas where coverage isn't desired, for instance, due to reflections of sound waves around corners. Such extended coverage may be desirable for lighting control, where the point is detection of any occupancy in an area. But for opening an automatic door, for example, one would prefer a sensor selective to traffic in the path toward the door.

### Tomographic Motion Detector.

Tomographic motion detection systems sense disturbances to radio waves as they pass from node to node of a mesh network. They have the ability to detect over complete areas because they can sense through walls and obstructions.

### Video Camera Software.

With the proliferation of inexpensive digital cameras capable of shooting video, it is possible to use the output of such a camera to detect motion in its field of view using software. This solution is particularly attractive when the intention was to record video triggered by motion detection, as no hardware beyond the camera and computer is required. Since the observed field may be normally illuminated, this may be considered another passive technology. However it can also be used in conjunction with near-infrared illumination to detect motion in the “dark” (that is, with the illumination at a wavelength not detected by the human eye).

These types of motion detectors typically measures optical, thermal, or acoustical changes in an area around the motion detector. The area that the motion detector detects motion is also referred to as a field of view.

A motion detector may be used to control the operation of a device. For example, a motion detector may initiate the operation of the device, stop the operation of the device, or change the manner in which the device operates.

Many modern motion detectors use combinations of different technologies, While combining multiple sensing technologies into one detector can help reduce false triggering, it does so at the expense of reduced detection probabilities and increased vulnerability. For example, many dual-tech sensors combine both a PIR sensor and a microwave sensor into one unit. In order for motion to be detected, both sensors must typically trip together but they can be configured to act independently of each other to trip the alarm.

Electronic temperature measuring devices such as resistance thermometers and thermocouples may be utilized to measure the vehicle cabin temperature and operate by correlating the electrical properties of a metal element with temperature. The resistance thermometer element is made from a pure material, typically platinum, nickel or copper. The relative change in resistance (temperature coefficient of resistance) varies only slightly over the useful range of the element.

Platinum is a noble metal and has the most stable resistance-temperature relationship over the largest temperature range. Nickel elements have a limited temperature range because the amount of change in resistance per degree of change in temperature becomes very non-linear at temperatures over 572° F. (300° C.). Copper has a very linear resistance-temperature relationship, however copper oxidizes at moderate temperatures and cannot be used over 302° F. (150° C.). Resistance thermometers are constructed in a number of forms and offer greater stability, accuracy and repeatability in some cases than thermocouples. While thermocouples use the Seebeck effect to generate a voltage, resistance thermometers use electrical resistance and require a power source to operate. The resistance ideally varies nearly linearly with temperature per the Callendar Van-Dusen equation.

Thermocouples may be used instead of resistance thermometers. A thermocouple is a temperature-measuring device consisting of two dissimilar conductors that contact each other at one or more spots, where a temperature differential is experienced by the different conductors (or semiconductors). The thermocouple produces a voltage when the temperature of one of the spots differs from the reference temperature at other parts of the circuit.

### SUMMARY

The system of the present application utilizes a motion detector actuated by a temperature sensor within the cabin of a vehicle. The motion detector 2 is preferably sited on the interior of the vehicle's roof. Ideally the motion detector is shielded to prevent detection of movement from outside of the vehicle. The motion detector is only actuated when the temperature of the vehicle cabin falls outside of a preset safe temperature range.

### BRIEF DESCRIPTION OF THE DRAWINGS

FIG. 1 depicts a perspective view of a preferred embodiment of the system installed in a vehicle with a motion detector mounted to the roof of the vehicle cabin.

FIG. 1a depicts a perspective view of the system installed in a vehicle with motion detectors mounted above the vehicle doors.

FIG. 1b depicts a perspective view of the system installed in a vehicle with a motion detector installed in the vehicle door.

FIG. 1c depicts a perspective view of the system installed in a vehicle with a motion detector installed in the vehicle center console.

FIG. 1d depicts a perspective view of the system installed in a vehicle with a motion detector installed in the vehicle door.

FIG. 2 depicts the process flow of the invention.

### DETAILED DESCRIPTION OF THE PREFERRED EMBODIMENTS

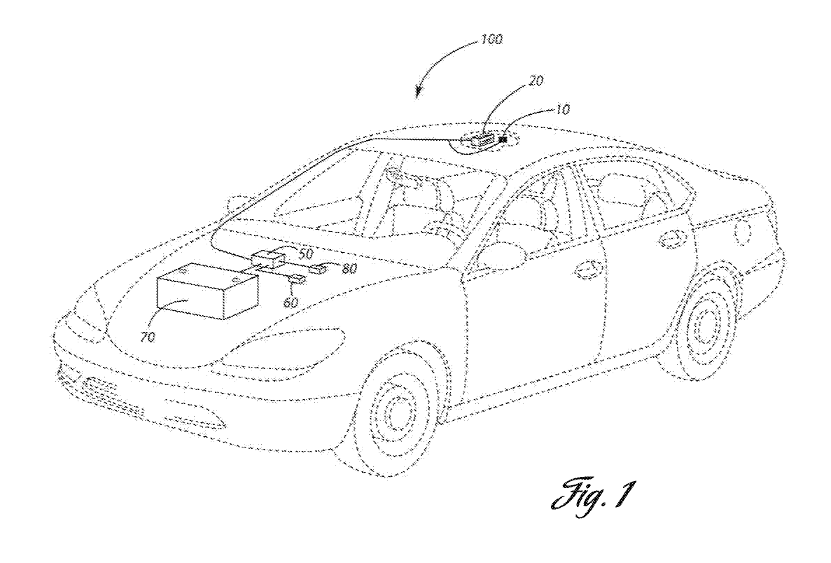

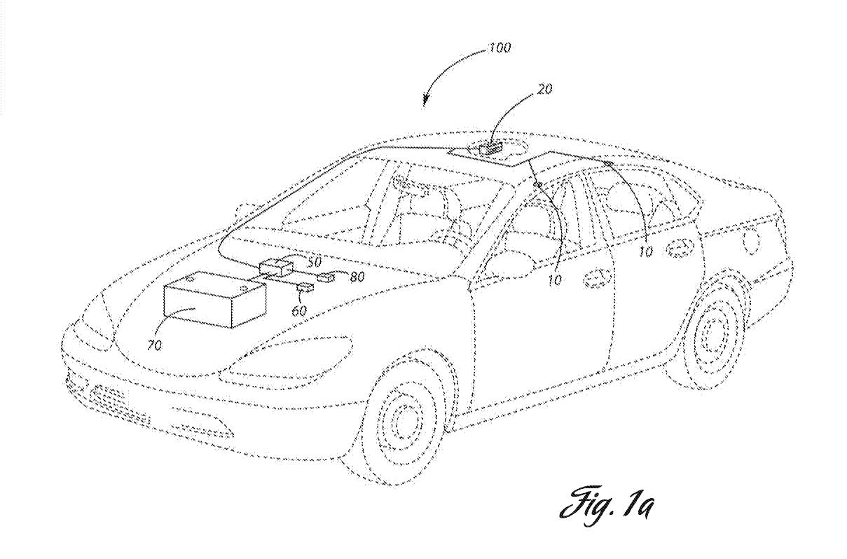

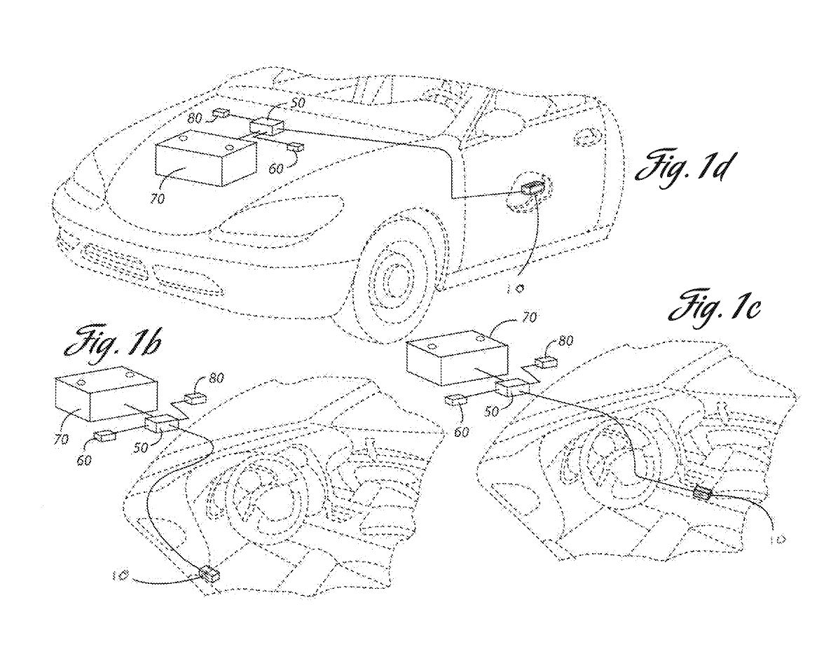

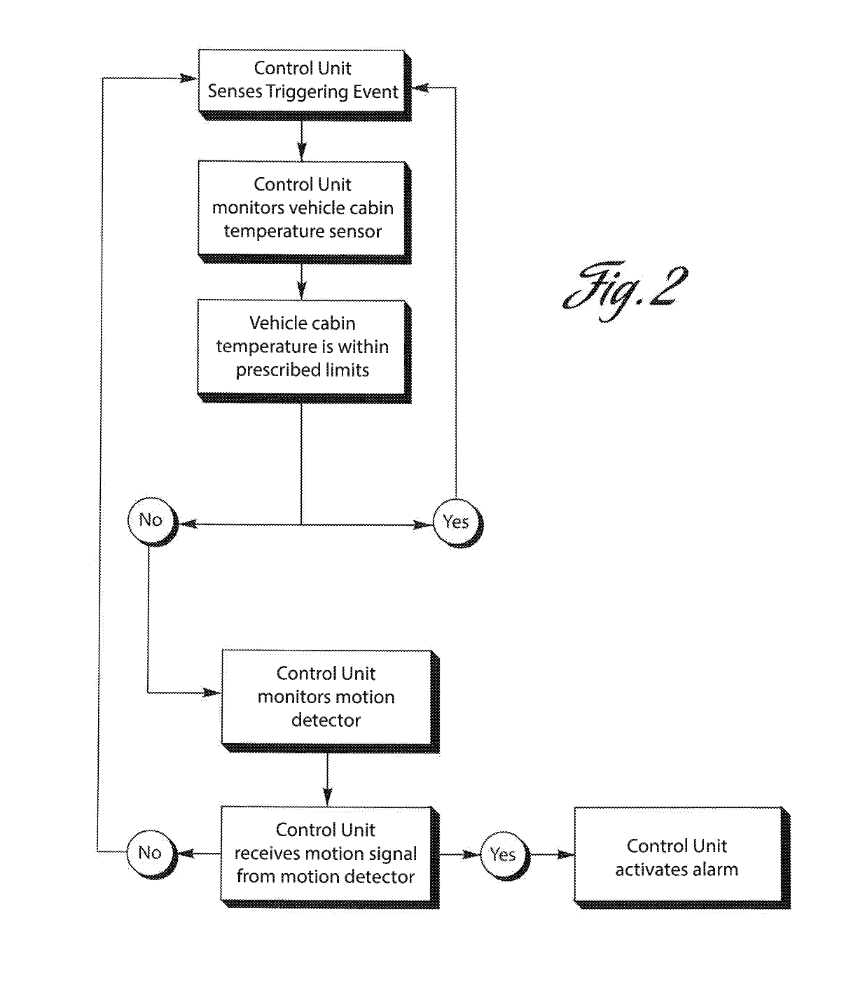

A vehicle safety system 100 to signal that a vehicle is occupied while cabin temperatures are outside of an optimal range is disclosed in FIGS. 1-2. At least motion detector 20, preferably powered by the vehicle battery 70, is arranged to detect movement within a vehicle's cabin. The motion detector 20 is preferably unpowered until activated by a control unit 50. The control unit 50 is in communication with a vehicle cabin temperature measuring device 10. The vehicle cabin temperature measuring device 10 can be one the vehicle already utilizes in its climate control system. The control unit 50 may be in communication with the vehicle's computer 60 through which it may power and/or monitor the vehicle cabin temperature sensor 10. Alternatively, the vehicle's computer 60 may serve as the control unit 50.

In a preferred embodiment, a motion detector 20 is mounted on the ceiling of the vehicle cabin. The motion detector 20 is aligned to detect movement in the front or rear seats while being shielded to avoid detecting motion alongside the outside of the vehicle. The motion detector 20 is powered by the car battery and operates only when the vehicle is turned off. In an alternative embodiment, the motion detector 20 is only powered for a preset amount of time after the vehicle is turned off. In a preferred alternative embodiment, the motion detectors 20 can be mounted in the floor of the vehicle. In yet another preferred alternative embodiment, the motion detectors 20 can be mounted in the interior surface of the vehicle doors. In yet another preferred alternative embodiment, the motion detectors 20 can be mounted to the center console between the front seats. In a still further preferred embodiment, two or more motion detecting technologies are utilized.

A plurality of motion detectors 20 may be used to provide improved detection by having at least one detector act as a failsafe mechanism in case another fails. A plurality of motion detectors 20 may also be used to eliminate or reduce false positives by requiring affirmative signals from a plurality of motion detectors 20 prior to activating an alarm 80.

Various motion detection technologies can be utilized to achieve the desired results. These technologies include infrared, optics, radio frequency, acoustic, and vibration.

Embodiments of preferred motion detection technologies include the following:

### Tomographic Motion Detectors 20.

Tomographic motion detectors 20 sense disturbances to radio waves as they pass from node to node of a mesh network. They have the ability to detect motion over complete areas because they can sense through walls and obstructions. Tomographic motion detectors 20 have the added advantage of hidden installation and have the option of requiring multiple counts of motion prior to triggering an alert.

Recent research and advancements have developed motion and presence sensing techniques that utilize received signal strength (RSS) measurements from wireless devices. For example, researchers have demonstrated motion detection using RSS measurements in IEEE 802.15.4/802.11 networks. Also, radio tomographic imaging (RTI) techniques have been developed to image large scale areas and are analogous to computed tomography technologies used to image inside the human body for medical purposes. RTI results can be processed to detect motion, count people, detect presence of people or objects, and locate individuals. Researchers have demonstrated that it is possible to estimate the number of people standing along a single data link by examining changes to signal strength. Researchers have also shown a statistical inversion method for locating and detecting humans within a wireless network using only signal strength.

When an object is located near a wireless communication link, the object may disturb the radio waves as they pass through, causing changes in the measured signal strength at a receiver. These changes and disturbances can be used to infer motion, presence, location, quantity, and other characteristics of the objects.

### PIR Sensors.

The most widely used motion detecting sensors 20 in terms of utility, energy savings and cost savings are PIR (Passive Infrared) based sensors 20. These sensors 20 detect motion and switch on any electrical/electronic device to which they are connected. The key component of the PIR sensor module is the pyro-electric element. There usually is a minimum of 2 elements which enable noise cancellation and enhanced detection.

Passive infrared sensors 20 detect changes in IR (infrared radiation) that is triggered by any hot moving body such as human or any other warm blooded animal movement. All this motion represents a time varying IR shift which triggers small signal fluctuations in the pyroelectric element. These small signal fluctuations are amplified and signal conditioned in the signal conditioning circuit.

Although FIR sensors 20 are very inexpensive, they suffer from significant false alarm and detection vulnerabilities. Changes in temperature will cause the PIR sensor 20 to trip. HVAC vents, outdoor air flow, sunlight, headlights, insects, and many other forms of harmless environmental changes may cause false triggering in a FIR sensor 20. PIR sensors 20 also have severe detection weaknesses. Lenses deteriorate or are coated over time (especially in dirty environments) until the sensor will not function properly.

One important aspect of PIR sensors 20 is that the front end sensor is a passive energy component which implies that it does not actively emit energy in order to detect motion. Hence, during prolonged idle operations when there is little or no movement that is to be detected, these sensors 20 are more energy efficient. Further, this feature attains higher prominence when these sensors 20 are being used for electrical energy conservation since the energy consumption of PIR control switches is minimal.

### Ultrasonic Sensors.

Ultrasonic motion detecting sensors 20 fall into the category of active sensors because the front end sensor actively emits sound waves at ultrasonic frequencies which in turn require a continuous supply of energy for the motion detecting sensor 20.

Ultrasonic sensors 20 unlike PIR sensors 20 have a continuous detection field which is un-segmented thus eliminating the prospect of dead zones where small movement detection becomes impossible.

The major drawback of ultrasonic sensors 20 is false activation or nuisance triggering since the ultrasound detection range can leak into adjacent spaces where motion detection is undesirable. Further, any movement of inert specimens such as temperature stabilized or random airflow can trigger these sensors. When used for electrical energy conservation purposes such as when battery powered, the ultrasonic sensor 20 partially loses its purpose since the energy consumption is much higher when compared to PIR sensors 20.

### Microwave Sensors and CW (Continuous Wave) Radar Based Sensors.

Microwave sensors and CW Radar sensors are quite similar to ultrasonic sensors since these sensors also belong to the category of active sensors and also have transceiver elements which can both emit and detect microwave and CW radio signals. The major difference between a microwave/CW radar sensor and an ultrasonic sensor is that microwave and CW radar sensors emit electromagnetic waves unlike high frequency sound waves emitted by an ultrasonic sensor. These sensors are usually more cost and energy expensive than ultrasonic sensors. In terms of relative merits and de-merits they are on par with ultrasonic sensors.

### Image Processing Sensors.

Motion detecting sensors 20 based on image processing are used in occupancy sensing applications where the area to be sensed is highly segmented. The best example for a segmented sensing of occupancy would be the aisles of a supermarket store. Each aisle can be monitored using individual or a wide angle camera. The video feed can be image processed in a control and processing unit to detect human occupancy which in turn can control light fixtures or other smart product address systems to customers in different aisles. The main shortcoming of this type of a sensor unit 20 is its very high initial setup cost.

Image processing sensors 20 excel in applications where a high level of visual detail is required, but they suffer from significant false alarm issues in many applications. Even a small insect landing on a camera lens can cause a false alarm, and changes in lighting (sunlight, headlights) are problematic.

In an embodiment, the control unit 50 actuates the temperature sensor 10 when the vehicle is turned off. Alternatively, an additional required event or plurality of events would also be required such as the shutting of all of the vehicle doors, rolled up windows, and/or the expiration of a timer. Preferably, there would be a manual override to temporarily disable the system 100.

In a preferred embodiment, the control unit 50 monitors the vehicle data to ascertain triggering events such as turning the vehicle off, the position of the windows, the closing of the doors, etc. Any sensor in the vehicle could presumably be utilized to generate a triggering event. Preferably closed doors and closed windows trigger a timer in the control unit 50. Upon the expiration of the timer, the control unit 50 begins to monitor the internal vehicle cabin temperature. Once the cabin temperature falls outside of a preprogrammed safe zone, e.g. 45° F. to 80° F., the motion detectors 20 within the vehicle cabin are activated. Upon sensing motion, the motion detectors 20 send a signal back to the control unit 50 which then activates an alarm 80.

In a preferred embodiment, the alert mechanism 80 is the vehicle's car alarm 80. In a further preferred embodiment, the alert mechanism 80 is the vehicle's online assistance network, e.g. On Star or Blue Link. An online assistance network can alert the driver via cell phone and/or alert a first responder as to the need for assistance.

While the present invention may have been disclosed herein with reference to certain embodiments, it will be apparent that modifications and variations are possible without departing from the spirit and scope of the invention as defined herein. Furthermore, it should be appreciated that any and all examples in the present disclosure, while illustrating embodiments of the invention, are provided as non-limiting examples and are, therefore, not to be taken as limiting the various aspects so illustrated. The present invention is intended to have its full scope consistent with the drawings and description herein, and equivalents thereof. Accordingly, the drawings and detailed description are to be regarded as illustrative and not as restrictive.

What is claimed is:

1. An occupied vehicle detector apparatus comprising a control unit for controlling the apparatus, an vehicle cabin temperature measuring device in communication with said control unit, a motion detector controlled by and in communication with said control unit, and a means to signal an alarm.

2. The apparatus of claim 1, wherein said control unit receives a signal from said temperature measuring device which said control unit interprets to ascertain the vehicle cabin temperature.

3. The apparatus of claim 2, wherein said control unit activates said motion detector when said vehicle cabin temperature falls outside of a preset range of acceptable vehicle cabin temperatures.

4. The apparatus of claim 3, wherein said motion detector is arranged to detect motion within said vehicle's cabin but not outside of said vehicle's cabin.

5. The apparatus of claim 4, wherein said motion detector, electronic temperature measuring device, control unit, and alarm system are powered by at least one rechargeable battery which is recharged by said vehicle's electrical system.

6. The apparatus of claim 5, wherein said battery is the vehicle system battery.

7. The apparatus of claim 5, wherein said motion detector communicates a vehicle occupied signal received by said control unit when motion is detected.

8. The apparatus of claim 7, wherein said control unit activates an alarm when it receives a vehicle occupied signal from said motion detector when said vehicle cabin temperature falls outside of said preset range of acceptable vehicle cabin temperatures.

9. The method of protecting a vehicle occupant from unsafe vehicle cabin temperatures by sensing a vehicle's cabin temperature with a temperature sensor, sensing movement within said vehicle's cabin with a motion detector sensor, processing the data from said temperature sensor and said motion detector sensor, and generating an alarm signal if movement is detected within said vehicle's cabin while said vehicle cabin temperature lies outside of a predetermined range of safe vehicle cabin temperatures.
